(19) United States
(12) Patent Application Publication
(10) Pub. No.: US 2021/0311281 A1
(43) Pub. Date: Oct. 7, 2021

(54) LENS DEVICE, IMAGING DEVICE, AND MOBILE OBJECT

(71) Applicant: VICTOR HASSELBLAD AB, GÖTENBORG (SE)

(72) Inventors: Masahiro SHIRONO, Tokyo (JP); Longji BAI, Tokyo (JP)

(21) Appl. No.: 17/351,218

(22) Filed: Jun. 17, 2021

Related U.S. Application Data
(63) Continuation of application No. PCT/CN2019/122374, filed on Dec. 2, 2019.

(30) Foreign Application Priority Data
Dec. 20, 2018 (JP) 2018-238444

(51) Int. Cl. G02B 7/02

(52) U.S. Cl. CPC G02B 7/021

(57) ABSTRACT

A lens device includes a lens, a mobile frame used to move with the lens, a cam pin arranged at a surface of the mobile frame, a cam ring having a cam groove used to guide the cam ring, a nut provided in a cavity of the mobile frame, and a screw used to fix the cam pin at the mobile frame by fastening with the nut.

### CROSS-REFERENCE TO RELATED APPLICATIONS

This application is a continuation of International Application No. PCT/CN2019/122374, filed Dec. 2, 2019, which claims priority to Japanese Patent Application No. 2018-238444, filed Dec. 20, 2018, the entire contents of both of which are incorporated herein by reference.

### TECHNICAL FIELD

The present disclosure relates to a lens device, an imaging device, and a mobile object.

### BACKGROUND

Patent document 1 discloses a technique of threading a first lens frame and a second lens frame through a cam pin. Patent document 1: Japanese Patent Application Publication No. 2000-66076.

### SUMMARY

In accordance with the disclosure, there is provided a lens device including a lens, a mobile frame used to move with the lens, a cam pin arranged at a surface of the mobile frame, a cam ring having a cam groove used to guide the cam ring, a nut provided in a cavity of the mobile frame, and a screw used to fix the cam pin at the mobile frame by fastening with the nut.

Also in accordance with the disclosure, there is provided an imaging device including an image sensor and a lens device. The lens device includes a lens, a mobile frame used to move with the lens, a cam pin arranged at a surface of the mobile frame, a cam ring having a cam groove used to guide the cam ring, a nut provided in a cavity of the mobile frame, and a screw used to fix the cam pin at the mobile frame by fastening with the nut.

Also in accordance with the disclosure, there is provided a mobile object configured to move, including an imaging device including an image sensor and a lens device. The lens device includes a lens, a mobile frame used to move with the lens, a cam pin arranged at a surface of the mobile frame, a cam ring having a cam groove used to guide the cam ring, a nut provided in a cavity of the mobile frame, and a screw used to fix the cam pin at the mobile frame by fastening with the nut.

### BRIEF DESCRIPTION OF THE DRAWINGS

FIG. 1 is a perspective view of an example imaging device.

FIG. 2 is a schematic functional block diagram of an example imaging device.

FIG. 3 shows an example of a cross-sectional view of a lens unit.

FIG. 4 is an enlarged schematic diagram of part 500 in FIG. 3.

FIG. 5 shows an example of a cross-sectional view of a lens unit according to an example embodiment.

FIG. 6 is an enlarged schematic diagram of part 502 in FIG. 5.

FIG. 7 is a schematic diagram showing a fixed part of a cam pin and a mobile frame.

FIG. 8 is a schematic diagram showing a state in which a cam pin and a nut are set on a mobile frame.

FIG. 9 is a schematic diagram showing a state in which a screw is partially inserted in a through hole.

FIG. 10 is a schematic diagram showing a state in which a screw passes through a through hole of a cam pin and a through hole of a mobile frame and is fastened by a nut.

FIG. 11 is a diagram showing an example appearance of an unmanned aerial vehicle and a remote control.

Reference numerals: UAV 10; UAV main body 20; Mobile frame 40, 400; First lens frame 41, 410; Second lens frame 42, 420; Cam pin 43, 430; Fixation cylinder 44, 440; Cam ring 45, 450; Self-tapping screw 46; Gimbal 50; Imaging device 60; Imaging device 100; Imaging unit 102; Imaging controller 110; Image sensor 120; Memory 130; Display 160; Instruction device 162; Lens unit 200; Lens 210; Lens moving mechanism 212; Lens controller 220; Memory 222; Remote control 300; Light amount control mechanism 35, 350; Recess 402; Bottom surface 403; Through hole 404, 432; Side surface 405; First lens group 415; Second lens group 425; Screw 460; Nut 470; Screw hole 472; Cavity 480; Adhesive 482.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The embodiments of the present disclosure will be described with reference to the flow charts and block diagrams. As used herein, the blocks may represent operation processes or components of the device that perform operations. The specific processes and components may be implemented by programmable circuits and/or processors. The circuits may include digital and/or analog hardware circuits, may include integrated circuits (ICs) and/or discrete circuits. The programmable circuits may include reconfigurable hardware circuits. The reconfigurable hardware circuits may include logical operations, such as the logical operation AND, the logical operation OR, the logical operation XOR, the logical operation NAND, and the logical operation NOR, etc. The reconfigurable hardware circuits may also include storage elements, such as flip-flops, registers, field programmable gate arrays (FPGAs), and programmable logic arrays (PLAs), etc.

The operations specified in the flow chart or block diagram may be implemented in the form of program instructions stored on a computer-readable storage medium, which may be sold or used as a standalone product. The computer-readable storage medium may be any suitable device that may store program instructions, which may include an electronic storage medium, a magnetic storage medium, an optic storage medium, an electromagnetic storage medium, and a semiconductor storage medium, etc. The computer-readable storage medium may be, for example, a floppy® disk, a soft disk, a hard disk, a random-access memory (RAM), a read-only memory (ROM), an erasable programmable read-only memory (EPROM or flash memory), an electrically erasable programmable read-only memory (EEPROM), a static random-access memory (SRAM), a compact disc read-only memory (CD-ROM), a digital versatile disc (DVD), a Blu-ray® disc, a memory stick, or an integrated circuit chip, etc.

The computer-readable instructions may include any one of source code or object code described in any combination of one or more programming languages. The source code or the object code includes traditional procedural programming languages. The traditional programming language may be assembly instructions, instruction set architecture (ISA) instructions, machine instructions, machine-related instructions, microcode, firmware instructions, status setting data, an object programming language, e.g., Smalltalk, JAVA (registered trademark), or C++, etc., or “C” programming language. The computer-readable instructions may be provided locally or provided to a processor or a programmable circuit of a general-purpose computer, a special-purpose computer, or another programmable data processing device via a wide area network (WAN), e.g., a local area network (LAN), or the Internet. The processor or the programmable circuit may execute computer-readable instructions to perform the operations specified in the flow chart or block diagram. The processor may be a computer processor, a processing unit, a microprocessor, a digital signal processor, a controller, or a microcontroller, etc.

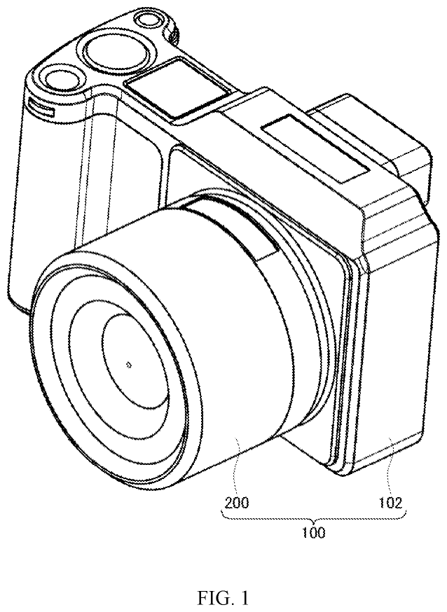

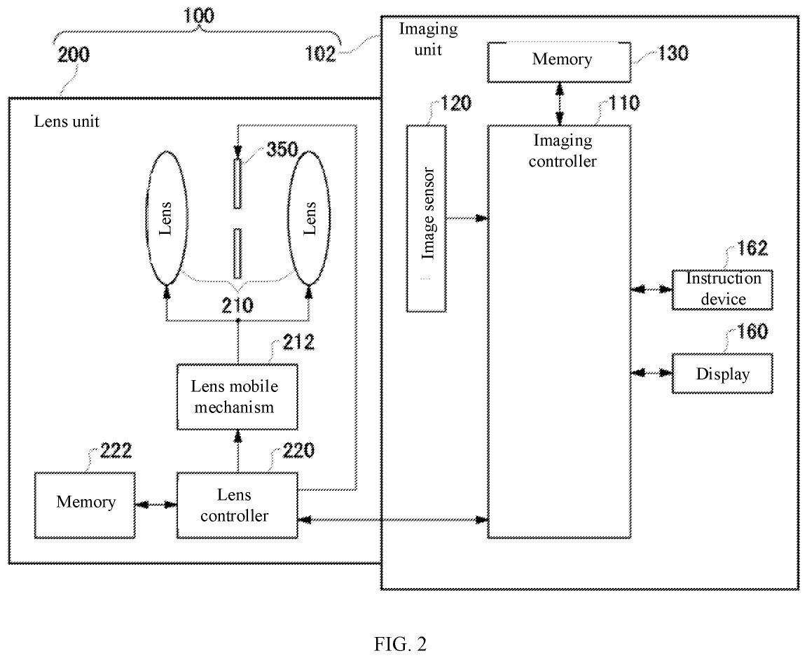

FIG. 1 is a perspective view of an imaging device 100 consistent with embodiments of the disclosure. FIG. 2 is a schematic functional block diagram of the imaging device 100.

The imaging device 100 includes an imaging unit 102 and a lens unit 200. The imaging unit 102 includes an image sensor 120, an imaging controller 110, and a memory 130. The image sensor 120 may include a charge coupled device (CCD) or a complementary metal oxide semiconductor (CMOS). The image sensor 120 outputs image data of the optic image formed by the lens 210 to the imaging controller 110. The imaging controller 110 may include the microprocessor, e.g., a central processing unit (CPU) or a microprocessor unit (MPU), or a microcontroller, e.g., a microprogrammed control unit (MCU), etc. The memory 130 may be the computer-readable storage medium and may include at least one of an SRAM, a dynamic random-access memory (DRAM), an EPROM, an EEPROM, or a flash memory such as a USB memory. The memory 130 stores a program for the imaging controller 110 to control the image sensor 120, etc. The memory 130 may be provided inside a casing of the imaging device 100. The memory 130 may be detachably mounted at the casing of the imaging device 100.

The imaging unit 102 further includes an instruction device 162 and a display 160. The instruction device 162 is a user interface receiving an instruction to the imaging device 100 from a user. The display 160 displays an image captured by the image sensor 120, various setting information of the imaging device 100, etc. The display 160 may include a touch panel.

The lens unit 200 includes a plurality of lenses 210, a light amount control mechanism 350, a lens moving mechanism 212, and a lens controller 220. The plurality of lenses 210 may be used as a single focal length lens. The plurality of lenses 210 are movably arranged along an optical axis. The lens unit 200 may be an interchangeable lens detachably mounted to the imaging unit 102. The lens moving mechanism 212 enables the plurality of lenses 210 to move along the optical axis. The lens controller 220 drives the lens moving mechanism 212 to enable one or more lenses 210 to move along the optical axis according to a lens control instruction from the imaging unit 102. The lens moving mechanism 212 may include a motor, a cam ring driven by the motor, and a mobile frame that moves along with the lens in an optical axis direction as the cam ring rotates. The motor may include a step motor, a DC motor, a coreless motor, or an ultrasonic motor.

The lens unit 200 also includes the memory 222. The memory 222 stores control values for the plurality of lenses 210 to be moved via the lens moving mechanism 212. The memory 222 may include the at least one of an SRAM, a DRAM, an EPROM, an EEPROM, or a flash memory such as a USB memory.

The light amount control mechanism 350 controls a light amount of light incident on the image sensor 120. The light amount control mechanism 350 includes at least one of an aperture mechanism or a shutter mechanism. The light amount control mechanism 350 may include a plurality of aperture blades. The light amount control mechanism 350 may include an actuator. The actuator may include an electromagnetic actuator. The electromagnetic actuator may include an electromagnet, a solenoid, or a step motor. The light amount control mechanism 350 may receive an instruction from the lens controller 220, drive the actuator, adjust an overlapping degree of the plurality of aperture blades, and adjust a size of an aperture.

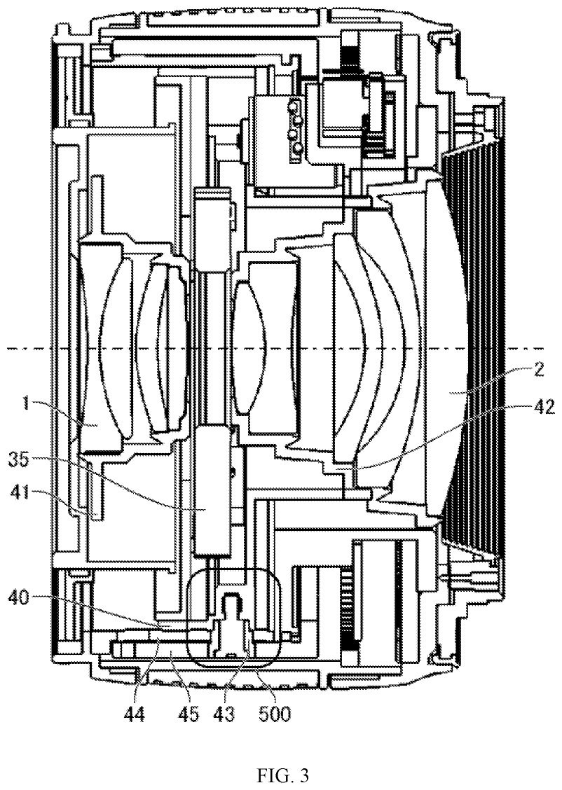

FIG. 3 shows an example of a cross-sectional view of the lens unit 200. The lens unit 200 includes a first lens frame 41 for holding a subject-side first lens group 1. The lens unit 200 includes a second lens frame 42 for holding an image-side second lens group 2. The lens unit 200 includes a light amount control mechanism 35 arranged between the first lens frame 41 and the second lens frame 42. In addition, the lens unit 200 includes a mobile frame 40 for holding the first lens frame 41, the second lens frame 42, and the light amount control mechanism 35. A cam pin 43 is fixed at an outer peripheral surface of the mobile frame 40. The lens unit 200 includes a fixation cylinder 44 having a cam groove in the optical axis direction at the outer peripheral surface of the mobile frame 40, and a cam ring 45 provided at an outer surface of the fixation cylinder 44 and having a cam groove corresponding to a movement amount of the first lens group 1 and the second lens group 2. When the cam ring 45 rotates relatively to the fixation cylinder 44, the cam pin 43 is guided by the cam groove, and the mobile frame 40 moves in the optical axis direction together with the first lens group 1 and the second lens group 2.

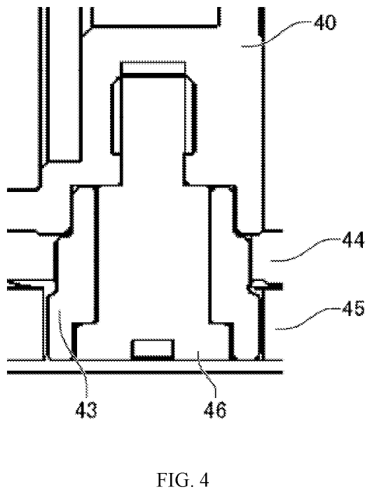

FIG. 4 is an enlarged schematic diagram of part 500 in FIG. 3. When the mobile frame 40 is made of resin, the cam pin 43 may be fixed to the mobile frame 40 with a self-tapping screw 46. However, when the cam pin 43 is fixed to the mobile frame 40 with the self-tapping screw 46, a force of the cam pin 43 to the mobile frame 40 is weak. Therefore, when the cam pin 43 receives an impact, the cam pin 43 may deviate in position relative to the mobile frame 40. Therefore, a nut may be embedded in the mobile frame 40 to increase a strength of a screw fixing part. For example, a metal nut may be embedded in an interior by insert molding, and the mobile frame 40 is molded with resin. However, when insert molding is performed, a position accuracy of the nut may fluctuate, and the cam pin 43 may not be fixed to the mobile frame 40 accurately.

Therefore, in an example embodiment of the present disclosure, the cam pin 43 is fixed to the mobile frame 40 accurately without being affected by fluctuations in the accuracy of the nut position.

FIG. 5 shows an example of a cross-sectional view of the lens unit 200 according to an example embodiment. The lens unit 200 includes a mobile frame 400, a first lens frame 410, a second lens frame 420, and a light amount control mechanism 350. The first lens frame 410 holds a subject-side first lens group 415 including a plurality of lenses. The second lens frame 420 holds an image-side second lens group 425 including a plurality of lenses. The first lens group 415 and the second lens group 425 are included as examples of the lens 210.

The light amount control mechanism 350 is interposed between the mobile frame 400 and the second lens frame 420 and fixed at the mobile frame 400. A cam pin 430 is fixed at an outer peripheral surface of the mobile frame 400. A plurality of cam pins 430 may be radially arranged at the outer peripheral surface of the mobile frame 400. The mobile frame 400 includes a fixation cylinder 440 at an outer surface of the cylinder. The fixation cylinder 440 has a cam groove used to guide the cam pin 430 in the optical axis direction. A cam ring 450 is provided at the outer surface of the fixation cylinder 440. The cam ring 450 has a cam groove corresponding to a movement amount of the first lens group 415 and the second lens group 425. The cam ring 450 is rotatably supported at the fixation cylinder 440.

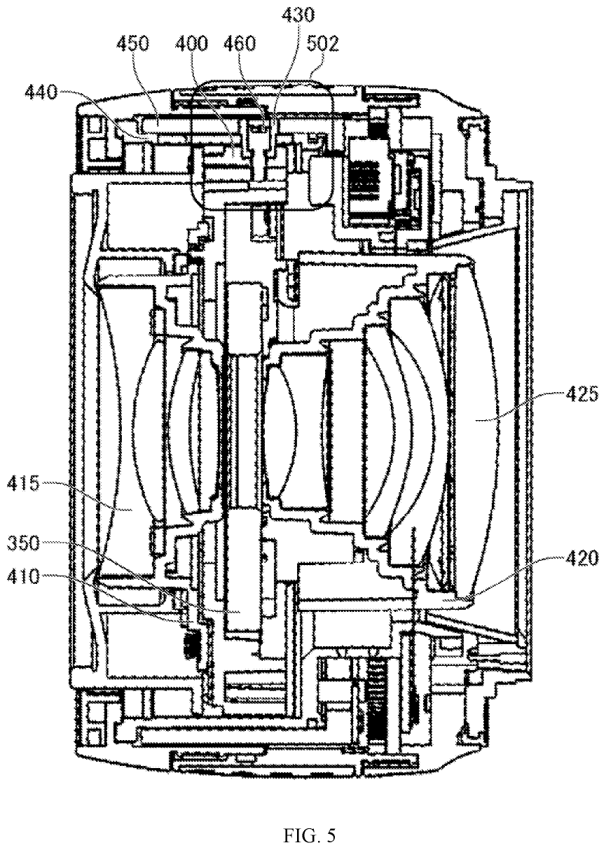

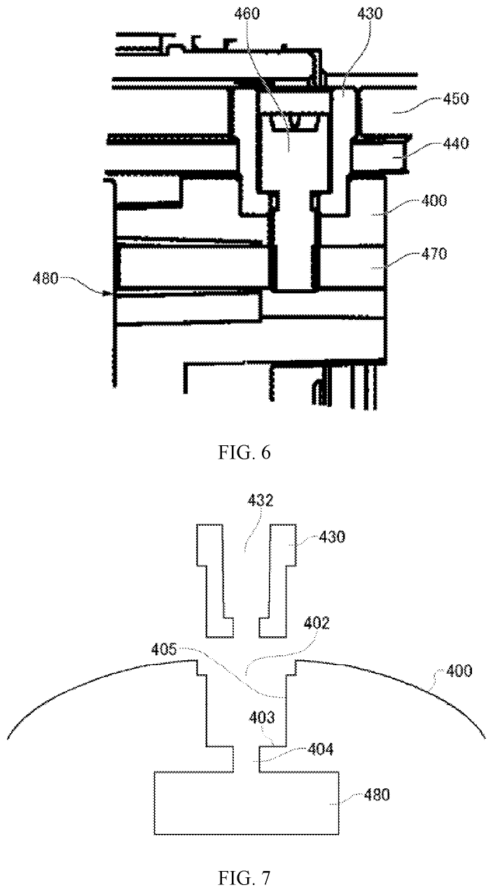

FIG. 6 is an enlarged schematic diagram of part 502 in FIG. 5. The mobile frame 400 has a cavity 480 including a nut 470 inside. A screw 460 passes through a through hole of the cam pin 430 and a through hole of the mobile frame 400, and is fastened by a nut 470. The cam pin 430 is fixed at the mobile frame 400. The mobile frame 400 may be made of resin. The screw 460 and the nut 470 may be made of resin. The nut 470 may include a plate nut or a square nut.

FIG. 7 is a schematic diagram showing a fixed part of the cam pin 430 and the mobile frame 400. The mobile frame 400 includes a recess 402 for arranging the cam pin 430. The cam pin 430 is positioned by a side surface 405 of the recess 402.

The cam pin 430 has the through hole 432 for inserting the screw. The mobile frame 400 has the cavity 480 for accommodating the nut 470 directly below the recess 402. The recess 402 has a through hole 404 that penetrates to the cavity 480 on a bottom surface 403. The mobile frame 400 can be made by injection molding of resin. The cavity 480 may be formed at the mobile frame 400 during or after injection molding. A material used for making the nut 470 includes, for example, stainless steel SUS304. The material used for making the mobile frame 400, the first lens frame 410, and the second lens frame 420 includes, for example, polycarbonate PC-GF 30%.

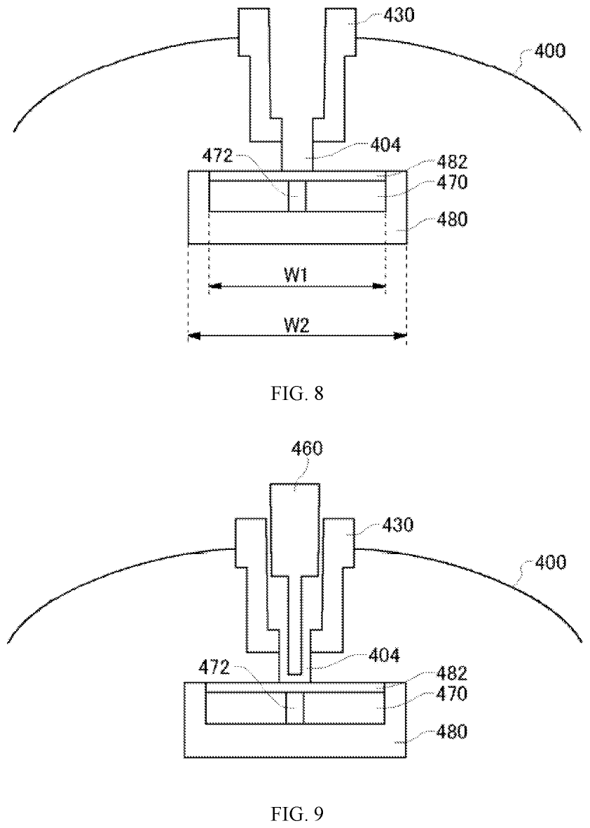

FIG. 8 is a schematic diagram showing a state in which the cam pin 430 and the nut 470 are set on the mobile frame 400. The moving frame 400 has an opening connected with the cavity 480 at a surface of at least one of the object side or the image side. The nut 470 can be inserted into the cavity 480 from the opening. The nut 470 can be adhered to a wall surface of the cavity 480 by an adhesive 482. The nut 470 can also be adhered to a side wall of the cavity 480 by filling the adhesive into the cavity 480 with the nut 470 inserted into the cavity 480. For example, the adhesive 482 may include an elastic adhesive, such as an ultraviolet curable resin or a UV curable epoxy adhesive. The nut 470 can also move after the nut 470 is adhered by using the elastic adhesive. Thus, even if the positions of a screw hole 472 of the nut 470 and the through hole 404 deviate, when the screw 460 is fastened by the nut 470, the nut 470 can move to eliminate the position deviation between the screw hole 472 and the through hole 404.

In addition, to allow the nut 470 to move in the cavity 480, a width W2 of the cavity is greater than a width W1 of the nut 470. In addition, a diameter of the through hole 404 of the mobile frame 400 is larger than a diameter of the screw hole 472 of the nut 470. Accordingly, even if the nut 470 is slightly deviated from the through hole 404, the screw 460 can be inserted into the screw hole 472 through the through hole 404. The through hole 404 of the mobile frame 400 does not play a role in positioning the cam pin 430.

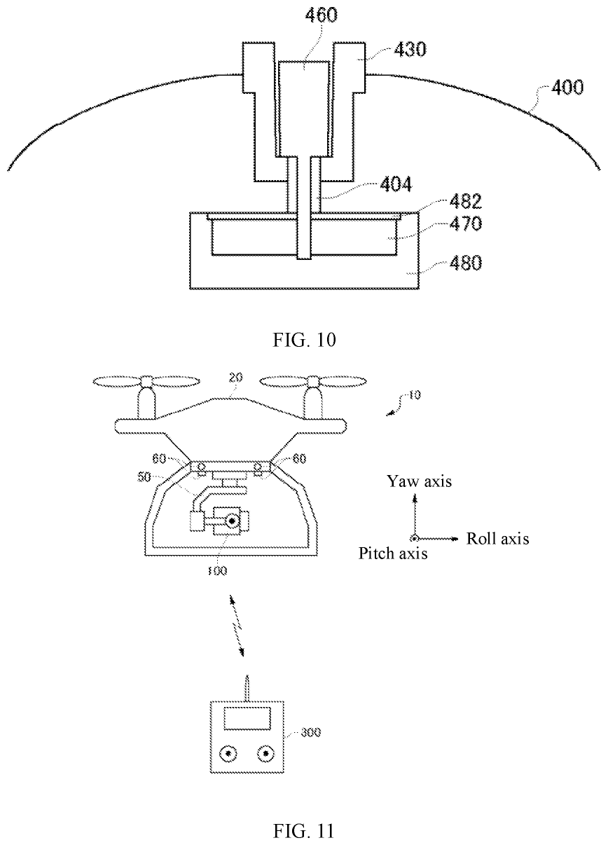

FIG. 9 is a schematic diagram showing a state in which the screw 460 is partially inserted in the through hole 404. FIG. 10 is a schematic diagram showing a state in which the screw 460 passes through the through hole 432 of the cam pin 430 and the through hole 404 of the mobile frame 400 and is fastened by the nut 470. As described above, because the adhesive 482 has elasticity, even if the nut 470 is slightly deviated from the cam pin 430, the nut 470 can move in the cavity 480. Thus, the nut 470 can move relative to the cam pin 430 by fastening the screw 460 to eliminate the positional deviation. In addition, the cam pin 430 and the mobile frame 400 are clamped and fixed by the nut 470 and the screw 460. Even if the cam pin 430 receives an impact, the position of the cam pin 430 relative to the mobile frame 400 can be prevented from deviating. When a self-tapping screw is used, to realize that the cam pin 430 does not deviate from the mobile frame 400 even if the cam pin 430 is impacted, the screw hole of the mobile frame 400 needs to have a certain thickness. However, when the screw 460 fastened with a nut 470 is used instead of using a self-tapping screw, the through hole 404 of the mobile frame 400 does not need to have too much thickness.

The screw 460 is fastened with the nut 470 to fix the cam pin 430. Even if the mobile frame 400 is made of resin, the cam pin 430 can be fixed at the mobile frame 400 accurately. In addition, the nut 470 is not embedded in the mobile frame 400 by insert molding, but inserted into the cavity 480 formed at the mobile frame 400 in advance. The cavity 480 has a space for the nut 470 to move. Furthermore, the nut 470 is adhered in the cavity 480 by the adhesive 482 having elasticity. Therefore, even if the nut 470 is adhered in the cavity 480 with a slight positional deviation, the positional deviation can be eliminated when the screw 460 is used for fastening.

The imaging device 100 as described above may be mounted at a mobile object. The imaging device 100 may also be mounted at an unmanned aerial vehicle (UAV) shown in FIG. 11. FIG. 11 is a diagram showing an example appearance of an unmanned aerial vehicle (UAV) 10 and a remote control 300. The UAV 10 includes a UAV main body 20, a gimbal 50, a plurality of imaging devices 60, and an imaging device 100. The gimbal 50 and the imaging device 100 are included as an example imaging system. The UAV 10 is included as an example mobile object propelled by a propulsion system. The mobile object may include a flight object movable in the air, a vehicle movable on the ground, or a ship movable on the water, etc. The flight object movable in the air may include an aircraft such as a UAV, an airship, or a helicopter, etc.

The UAV main body 20 includes a plurality of rotors. The plurality of rotors are included as an example propulsion system. The UAV main body 20 enables the UAV 10 to fly by controlling the rotation of the plurality of rotors. The UAV main body 20 uses, for example, four rotors to enable the UAV 10 to fly. The number of rotors is not limited to four. In addition, the UAV 10 may also be a fixed-wing aircraft without rotors.

The imaging device 100 includes an imaging camera used to shoot an object included in a desired shooting range. The gimbal 50 may rotatably support the imaging device 100. The gimbal 50 is included as an example supporting mechanism. For example, the gimbal 50 supports the imaging device 100 so that it may be rotated around a pitch axis using an actuator. The gimbal 50 supports the imaging device 100 to enable the imaging device 100 to rotate around a roll axis or a yaw axis using an actuator. The gimbal 50 may change the attitude of the imaging device 100 by rotating the imaging device 100 around at least one of the yaw axis, the pitch axis, or the roll axis.

The plurality of imaging devices 60 include sensing cameras used to shoot surroundings of the UAV 10 to control the flight of the UAV 10. Two of the imaging devices 60 may be mounted at the nose, i.e., at a front, of the UAV 10. In addition, another two of the imaging devices 60 may be mounted at a bottom of the UAV 10. The two imaging devices 60 at the front of the UAV 10 may be paired to function as a stereo camera. The two imaging devices 60 at the bottom of the UAV 10 may also be paired to function as a stereo camera. Three-dimensional spatial data around the UAV 10 may be generated according to images taken by the plurality of imaging devices 60. The number of the imaging devices 60 included in the UAV 10 is not limited to four. The UAV 10 includes at least one imaging device 60. The UAV 10 may include at least one imaging device 60 at each of the nose, tail, side, bottom, and top of the UAV 10. A settable viewing angle of the imaging device 60 may be larger than the settable viewing angle of the imaging apparatus 100. The imaging device 60 may have a single focus lens or a fisheye lens.

The remote control 300 communicates with the UAV 10 to operate the UAV 10 remotely. The remote control 300 may communicate with the UAV 10 wirelessly. The remote control 300 sends the UAV 10 instruction information indicating various instructions related to the movement of the UAV 10 such as ascending, descending, accelerating, decelerating, forwarding, retreating, and/or rotating. The instruction information includes, for example, the instruction information for raising a flight altitude of the UAV 10. The instruction information may indicate a desired flight altitude of the UAV 10. The UAV 10 may move to the desired flight altitude indicated by the instruction information received from the remote control 300. The instruction information may include an ascending instruction to instruct the UAV 10 to ascend. The UAV 10 may ascend after receiving the ascending instruction. When the flight altitude of the UAV 10 has reached a maximum flight altitude, even if the ascending instruction is received, the UAV 10 may be restricted from ascending.

An execution order of the actions, sequences, processes, and stages in the devices, systems, programs, and methods consistent with claims, specification, and drawings, as long as there is no special indication “before,” “in advance,” etc., and as long as an output of previous processing is not used in the subsequent processing, may be implemented in any order. Regarding the operating procedures in the claims, the specification, and the drawings, terms “first,” “next,” etc. used in the descriptions for convenience, but do not limit an implementation order.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A lens device comprising:
a lens;
a mobile frame configured to move with the lens;
a cam pin arranged at a surface of the mobile frame;
a cam ring having a cam groove configured to guide the cam ring;
a nut provided in a cavity of the mobile frame; and
a screw configured to fix the cam pin at the mobile frame by fastening with the nut.

2. The lens device of claim 1, wherein a recess is provided at the surface of the mobile frame, and the cam pin is arranged at the recess.

3. The lens device of claim 2, wherein:
the cam pin has a first through hole;
the recess has a second through hole at a bottom surface of the recess, the second through hole penetrating the mobile frame and being connected with the cavity; and
the screw is configured to pass through the first through hole and the second through hole to be fastened by the nut.

4. The lens device of claim 3, wherein a diameter of the second through hole is larger than a diameter of a screw hole of the nut.

5. The lens device of claim 2, wherein the cam pin is configured to be positioned by a side wall of the recess.

6. The lens device of claim 1, wherein the nut is adhered to an inner wall of the cavity by an adhesive.

7. The lens device of claim 6, wherein the adhesive has elasticity.

8. The lens device of claim 1, wherein a width of the cavity is larger than a width of the nut.

9. The lens device of claim 1, wherein the nut is plate-shaped.

10. The lens device of claim 1, wherein the nut and the screw are made of metal.

11. The lens device of claim 1, wherein the mobile frame is made of resin.

12. An imaging device comprising:
an image sensor; and
a lens device including:
a lens;
a mobile frame configured to move with the lens;
a cam pin arranged at a surface of the mobile frame;
a cam ring having a cam groove configured to guide the cam ring;
a nut provided in a cavity of the mobile frame; and
a screw configured to fix the cam pin at the mobile frame by fastening with the nut.

13. The imaging device of claim 12, wherein recess is provided at the surface of the mobile frame, and the cam pin is arranged at the recess.

14. The imaging device of claim 13, wherein the holding frame includes:
the cam pin has a first through hole;
the recess has a second through hole at a bottom surface of the recess, the second through hole penetrating the mobile frame and being connected with the cavity; and
the screw is configured to pass through the first through hole and the second through hole to be fastened by the nut.

15. The imaging device of claim 14, wherein a diameter of the second through hole is larger than a diameter of a screw hole of the nut.

16. The imaging device of claim 13, wherein the cam pin is configured to be positioned by a side wall of the recess.

17. The imaging device of claim 12, wherein the nut is adhered to an inner wall of the cavity by an adhesive.

18. The imaging device of claim 17, wherein the adhesive has elasticity

19. The imaging device of claim 12, wherein a width of the cavity is larger than a width of the nut.

20. A mobile object configured to move, comprising:
an imaging device including:
an image sensor; and
a lens device including:
a lens;
a mobile frame configured to move with the lens;
a cam pin arranged at a surface of the mobile frame;
a cam ring having a cam groove configured to guide the cam ring;
a nut provided in a cavity of the mobile frame; and
a screw configured to fix the cam pin at the mobile frame by fastening with the nut.
